(19) United States
(12) Patent Application Publication
(10) Pub. No.: US 2008/0247178 A1
(43) Pub. Date: Oct. 9, 2008

(54) COVERING FOR A LIGHT SOURCE FOR MAINTAINING BRIGHTNESS IN A DEGRADING ENVIRONMENT

(76) Inventor: David Holder, Laguna Niguel, CA (US)

Correspondence Address: Law Offices of Daniel L. Dawes, 5200 Warner Blvd, Ste. 106, Huntington Beach, CA, 92649, US

(21) Appl. No.: 11/957,176

(22) Filed: Dec. 14, 2007

Related U.S. Application Data
(60) Provisional application No. 60/875,066, filed on Dec. 15, 2006.

(51) Int. Cl. F21V 15/00; B32B 37/12

(52) U.S. Cl. 362/376; 156/60

(57) ABSTRACT

A covering for a light source is used to maintain light intensity of the light source when used in a degrading environment, such as one in which dirt, dust, grime, and abrasive particles are abundant and tend to be deposited on the lens or face plate of the light source, such as in an off-road vehicle. The covering includes a substantially transparent protective basal layer with a lower surface having a substantially transparent, removable adhesive coating. The basal layer is arranged and configured for removable adhesive affixation to the aperture surface of the light source. A plurality of substantially transparent protective layers, each having a lower surface, is disposed in sequence one on top of the other and on the basal layer to form a stack. Each of the plurality of layers has a removable adhesive coating disposed on their lower surface for affixation to an adjacent underlying layer.

### RELATED APPLICATIONS

The present application is related to U.S. Provisional Patent Application, Ser. No. /60/875,066, filed on Dec. 15, 2006, which is incorporated herein by reference and to which priority is claimed pursuant to 35 USC 119.

### BACKGROUND OF THE INVENTION

1. Field of the Invention

The invention relates to the field of lighting fixtures and sources in off-road, combat and industrial use vehicles.

2. Description of the Prior Art

Current LED light sources operate at lower temperatures than do traditional lighting means and therefore provide an opportunity to increase their utility in these vehicles. A company doing business under the name of Holder Off-Road Lighting in California introduced the first LED powered, off-road vehicular lighting system in the summer of 2006. While providing adequate amounts of light needed, LED light sources often operate at or near the minimum level of brightness needed in an application and do not have excess illumination capacity to waste. The driver of a vehicle used in dusty, dirty or debris laden conditions must wash, wipe or otherwise clean the protective or outer lens portion of the light source in order to maintain the lighting brilliance of the source at its desired maximum level. While debris, dust and abrasive protective tear off sheets are known for use on automotive windshields for racing cars and for dirt bike helmet visors, such sheets are unusable for light sources, including automotive lights, because the heat built up from the light source would melt or soften the sheets, melt the sheets together or otherwise degrade the optical and/or physical qualities of the sheets to render them unusable.

### BRIEF SUMMARY OF THE INVENTION

The illustrated embodiment of the invention provides a means to the driver of vehicles operated in dirty or dusty conditions for keeping road dirt and dust and other deposits from diminishing the light intensity of the LED light source or other low temperature light source, such as fluorescent lights. A “low temperature” light source is defined for the purposes of this specification as being of a light which when deployed in its fixture does not reach temperatures or accumulated heat exposures of such a magnitude or intensity such that the covering becomes either optically or physically degraded so that that covering cannot be practically used in the manner described below. The illustrated embodiment of the invention allows the driver to quickly remove the foreign substance buildup by simply removing a predetermined layer of plastic from the lens or cover of the light source and resume operation of the vehicle.

More specifically the illustrated embodiment of the invention is a covering for a light source having an aperture surface. The covering is used to maintain light intensity of the light source when used in a degrading environment, such as one in which dirt, dust, grime, and abrasive particles are abundant and tend to be deposited on the lens or face plate of the light source, such as in an off-road vehicle. The covering comprises a substantially transparent protective basal layer with a lower surface having an substantially transparent, removable adhesive coating disposed thereon. The basal layer is arranged and configured for removable adhesive affixation to the aperture surface of the light source. A plurality of substantially transparent protective layers, each having a lower surface, is disposed in sequence one on top of the other and on the basal layer to form a stack. Each of the plurality of layers has a removable adhesive coating disposed on their lower surface for affixation to an adjacent underlying layer.

In the preferred embodiment the light source comprises an LED light source, such as an off-road vehicular light source. The aperture surface of the light source which is protected comprises a lens or a face plate.

In the illustrated embodiment the stack comprises a planar stack or a rectangular stack. However, the stack may also comprise a contoured stack.

The covering further comprises an opaque or translucent layer disposed uppermost on the stack.

The covering further comprises at least one surface on at least one layer free of adhesive, or more specifically a tab. In some embodiments each layer in the stack includes a tab.

The illustrated embodiment is also a kit for providing a retrofitted covering for a light source having an aperture surface for maintaining light intensity of the light source when used in a degrading environment. The kit comprises a stack of substantially transparent protective layers removably adhesively adhered to each other. The stack is provided with a basal adhesive coating for attachment of the stack to the aperture surface of the light source.

Still further the illustrated embodiment includes a method of assembling a covering for a light source having an aperture surface for maintaining light intensity of the light source when used in a degrading environment. The method comprises the steps of providing a lower surface of a substantially transparent protective basal layer with an substantially transparent, removable adhesive coating disposed thereon. The lower surface of the basal layer is adapted for affixation to an aperture surface of the light source. A plurality of substantially transparent protective layers are affixed each in turn. Each layer has a lower surface and the layers are disposed in sequence one on top of the other and on the basal layer to form a stack. Each of the plurality of layers has a removable adhesive coating disposed on their lower surface for affixation to an adjacent underlying layer. Preferably the stack is removably affixed to an LED light source, such as an off-road vehicular light source.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is an exploded perspective view of a device according to the invention. The outer or first removed layer and the second removed layer are shown with an optional easy removal tab.

FIG. 2 is a perspective view of an LED off-road vehicular lighting system with the device of FIG. 1, still shown in exploded view, installed.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

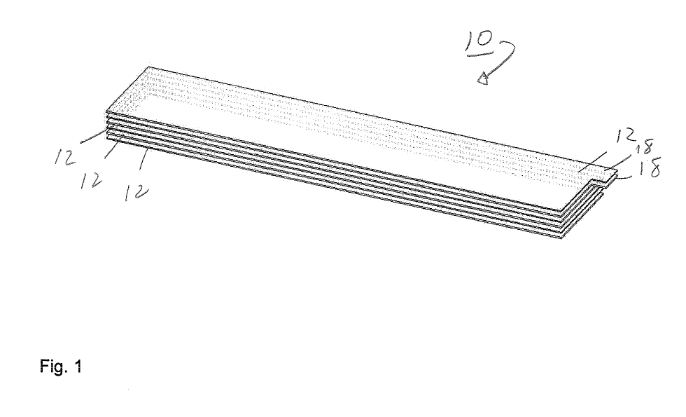

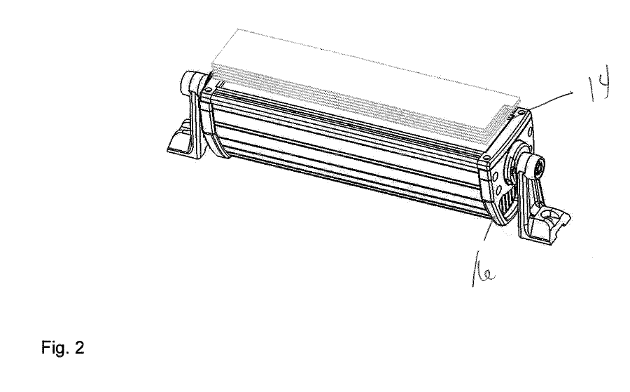

The illustrated embodiment of the invention as shown in the exploded perspective view of FIG. 1 is a stack 10 comprised of either a single or multiple layers of clear plastic layers 12 that are adhered or tacked to the outer cover or lens 14 of the lighting fixture 16 as shown in FIG. 2 by a substantially transparent removable adhesive layer provided or coated onto the bottom layer 12, such as a coating made of conventional 3M contact adhesives. The bottom surface of each layer 12 in the stack 10 is similarly coated with a substantially transparent removable adhesive layer to temporarily adhere the layer 12 to the next adjacent underlying layer 12in the stack 10. The plurality of layers 12 of stack 10 are similarly configured continuing up to the topmost layer 12, whose upper or exposed surface is free of an adhesive layer. In the preferred embodiment when the uppermost layer 12 is peeled away from stack 10, the exposed upper surface the next underlying layer 12 is substantially free from adhesive, since the adhesive coating is securely bonded to the overlying layer 12, but weakly bonded to the underlying layer 12. The adhesive coating is thus carried away as each layer 12 is removed, leaving the next exposed layer substantially free of any adhesive coating. In this manner, dirt, dust, or grime is not preferentially attached to the nearly exposed surface.

In fact, the upper surface of each layer 12 may be provided with anti-dust or other coating which make adhesion thereto by air-borne particulates less likely or scratches of the exposed surface less likely are currently available in the marketplace or may be later devised. In the preferred embodiment each layer 12 is provided with an identical type of adhesive on its lower surface. However, it is expressly contemplated that the basal or bottommost layer 12 in contact with lens 14 may be provided with a different type of adhesive that is specially adapted for the appropriate adhesion to the type of material from which lens 14 is made.

When a buildup of abrasion, scratches, dirt, grime or other substance begins to block or diminish the light output of fixture 16 significantly, the user is free to remove the outermost layer 12 of stack 10 revealing the next underlying clear, clean and unblemished layer 12, or in the case of the last layer 12, the lens 14 of fixture 16. As buildup recurs, the driver can remove successive layers 12.

Layers 12 can be made of any material can be any that is clear enough or translucent to provide optical transmission of light and which is physically strong enough to remain intact during the removal process, such as conventional polycarbonate plastic or other transparent plastics or sheet materials.

In one embodiment outer or first removed layer 12 may be opaque or translucent to provide a cover for the lighting fixture 16 before use.

The invention may optionally be provided with an adhesive-free portion or tab 18 as shown in FIG. 1 to allow for easy manual removal.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

For example, while the illustrated embodiment has been shown to be a flat rectangular stack 10, the two dimensional outline may assume any shape desired according the contour and outline of the lens or cover 14 which is presented. Rounded planar or partially spherical or contoured shapes are expressly contemplated so that stack 10 is comprised of a three-dimensional contoured stack 10 of contoured layers 12 with an arbitrary outline or border in order to fit over conventional vehicular headlight lenses. It is also contemplated that the material of layers 12 may have sufficient resiliency or compressive qualities to allow molding or shaping of the stack 10 to an arbitrary three-dimensional surface of lens 14.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A covering for a light source having an aperture surface, the covering for maintaining light intensity of the light source when used in a degrading environment comprising:
a substantially transparent protective basal layer with a lower surface having an substantially transparent, removable adhesive coating disposed thereon, the basal layer arranged and configured for removable adhesive affixation to the aperture surface of the light source, where the light source is a low temperature light source; and
a plurality of substantially transparent protective layers, each having a lower surface, disposed in sequence one on top of the other and on the basal layer to form a stack, each of the plurality of layers having a removable adhesive coating disposed on their lower surface for affixation to an adjacent underlying layer.

2. The covering of claim 1 where the light source comprises an LED light source.

3. The covering of claim 1 where the light source comprises an off-road vehicular light source.

4. The covering of claim 1 where aperture surface of the light source comprises a lens.

5. The covering of claim 1 where aperture surface of the light source comprises a face plate.

6. The covering of claim 1 where the stack comprises a planar stack.

7. The covering of claim 6 where the planar stack comprises a rectangular stack.

8. The covering of claim 1 where the stack comprises a contoured stack.

9. The covering of claim 1 further comprising an opaque or translucent layer disposed uppermost on the stack.

10. The covering of claim 1 further comprising at least one surface on at least one layer free of adhesive.

11. The covering of claim 10 where the one surface comprises a tab.

12. The covering of claim 11 where each layer in the stack includes a tab.

13. A kit for providing a retrofitted covering for a light source having an aperture surface, the covering for maintaining light intensity of the light source when Patent used in a degrading environment, the kit comprising a stack of substantially transparent protective layers removably adhesively adhered to each other, the stack being provided with a basal adhesive coating for attachment of the stack to the aperture surface of the light source:

14. The kit of claim 13 where the light source comprises an off-road vehicular LED light fixture.

15. A method of assembling a covering for a light source having an aperture surface for maintaining light intensity of the light source when used in a degrading environment comprising:
providing a lower surface of a substantially transparent protective basal layer with an substantially transparent, removable adhesive coating disposed thereon, the lower surface of the basal layer adapted for affixation to an aperture surface of the light source; and
affixing in turn a plurality of substantially transparent protective layers, each having a lower surface, disposed in sequence one on top of the other and on the basal layer to form a stack, each of the plurality of layers having a removable adhesive coating disposed on their lower surface for affixation to an adjacent underlying layer.

16. The method of claim 15 further comprising removably affixing the stack to an LED light source.

17. The method of claim 15 further comprising removably affixing the stack to an off-road vehicular light source.
